(19) United States
(12) Patent Application Publication
(10) Pub. No.: US 2015/0369975 A1
(43) Pub. Date: Dec. 24, 2015

(54) RETROREFLECTIVE SHEETING HAVING DEFORMED CUBE CORNER ELEMENTS

(71) Applicant: 3M INNOVATIVE PROPERTIES COMPANY, Saint Paul, MN (US)

(72) Inventors: Michael B. Free, St. Paul, MN (US); Martin B. Wolk, Woodbury, MN (US); Rolf W. Biernath, Wyoming, MN (US)

(21) Appl. No.: 14/762,637

(22) PCT Filed: Jan. 9, 2014
(86) PCT No.: PCT/US2014/010833

§ 371 Date: Jul. 22, 2015

Related U.S. Application Data
(60) Provisional application No. 61/757,343, filed on Jan. 28, 2013.

(51) Int. Cl. G02B 5/124; B29C 67/00; B42D 25/324

(52) U.S. Cl. CPC G02B 5/124; B42D 25/324; B29C 67/0044; B29K 2101/12

(57) ABSTRACT

Retroreflective article having tailored optical properties and method for making the same. Retroreflective articles according to the present application comprise deformed cube corner elements having reduced optically active volume and reduced active volume height. Exemplary retroreflective articles have at least one of minimized contrast caused by seam welds, tiling lines or defects under retroreflective conditions, markings discernible at different viewing conditions and reduced overall retroreflectivity.

The present application generally relates to novel retroreflective articles; and methods of making and using same. The present application more specifically relates to deformed cube corner elements in retroreflective sheeting. Exemplary uses of such retroreflective sheeting include, for example, signs, license plates, and printed sheeting.

### BACKGROUND

Retroreflective materials are characterized by the ability to redirect light incident on the material back toward the originating light source. This property has led to the widespread use of retroreflective sheeting for a variety of traffic and personal safety uses. Retroreflective sheeting is commonly employed in a variety of articles, for example, road signs, barricades, license plates, pavement markers and marking tape, as well as retroreflective tapes for vehicles and clothing.

Two known types of retroreflective sheeting are microsphere-based sheeting and cube corner sheeting. Microsphere-based sheeting, sometimes referred to as “beaded” sheeting, employs a multitude of microspheres typically at least partially embedded in a binder layer and having associated specular or diffuse reflecting materials (e.g., pigment particles, metal flakes or vapor coats, etc.) to retroreflect incident light. Due to the symmetrical geometry of beaded retroreflectors, microsphere based sheeting exhibits the same light return regardless of orientation, i.e., when rotated about an axis normal to the surface of the sheeting. For this reason, it is said that the distribution of light returned by beaded retroreflective sheeting is generally rotationally symmetric. Thus when viewing or measuring the coefficient of retroreflection (retroreflectivity) (expressed in units of candelas per lux per square meter or Ra) at presentation angles from 0 to 360 degrees, or when measuring at orientation angles from 0 to 360, there is relatively little variation in the retroreflectivity of beaded sheeting. For this reason, such microsphere-based sheeting has a relatively low sensitivity to the orientation at which the sheeting is placed on a surface. In general, however, such sheeting has a lower retroreflective efficiency than cube corner sheeting.

Cube corner retroreflective sheeting, sometimes referred to as “prismatic” sheeting, typically comprises a thin transparent layer having a substantially planar first surface and a second structured surface comprising a plurality of geometric structures, some or all of which include three reflective faces configured as a cube corner element. Cube corner retroreflective sheeting is commonly produced by first manufacturing a master mold that has a structured surface, such structured surface corresponding either to the desired cube corner element geometry in the finished sheeting or to a negative (inverted) copy thereof, depending upon whether the finished sheeting is to have cube corner pyramids or cube corner cavities (or both). The mold is then replicated using any suitable technique, such as nickel electroforming, to produce tooling for forming cube corner retroreflective sheeting by processes such as embossing, extruding, or cast-and-curing. U.S. Pat. No. 5,156,863 (Pricone et al.) provides an illustrative overview of a process for forming tooling used in the manufacture of cube corner retroreflective sheeting. Known methods for manufacturing the master mold include pin-bundling techniques, direct machining techniques, and techniques that employ laminae. These microreplication processes produce a retroreflective sheeting with prismatic structures that have been precisely and faithfully replicated from a microstructured tool having a negative image of the desired prismatic structure.

### SUMMARY

The present inventors recognized a need to efficiently tailor optical properties (e.g., retroreflectivity) of a retroreflective article. In one aspect, the inventors of the present application sought to develop a method to quickly modify a prismatic retroreflective sheeting, without the need to produce specific tooling. In another aspect, the present inventors sought to selectively modify optical properties of at least a portion of a prismatic retroreflective article. In yet another aspect, the present inventors sought to minimize the contrast caused by seam welds and/or tiling lines under retroreflective conditions. In another aspect, the present inventors sought to create markings discernible at different viewing conditions. In some instances, these markings are used to provide information as to the origin and/or type of retroreflective sheeting. In other instances, the markings are used as security features.

In one embodiment, the present application relates to a retroreflective sheeting comprising: a structured surface including cube corner elements having three generally perpendicular faces that meet at an apex; wherein the apex of at least 30 percent of the cube corner elements is thermally deformed, resulting in deformed cube corner elements.

In another embodiment, the present application relates to a retroreflective sheeting comprising: a structured surface including cube corner elements, wherein at least some of the cube corner elements are thermally sheared; and wherein the thermally sheared cube corner elements form a grayscale marking.

In yet another embodiment, the present application relates to a retroreflective sheeting comprising: a structured surface including an array of deformed cube corner elements having reduced optically active volumes, the array comprising multiple pixels, a first pixel comprising cube corner elements having a first total light return value and a second pixel, adjacent to the first pixel, comprising cube corner elements having a second total light return value, different from the first total light return value.

In another embodiment, the present application relates to a method of making a retroreflective article comprising: providing a retroreflective sheeting having a structured surface comprising cube corner elements having three generally perpendicular faces that meet at an apex; thermally deforming the apex of at least 30 percent of the cube corner elements to form deformed cube corner elements.

In another embodiment, the present application relates to a method of making a retroreflective article comprising: providing a retroreflective sheeting having a structured surface comprising a plurality of cube corner elements; thermally shearing at least some of the cube corner elements; wherein the thermally sheared cube corner elements form a grayscale marking.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

1. FIG. 1 is a cross-section of a retroreflective sheeting of the prior art.

FIG. 2 is a cross-section of an exemplary retroreflective sheeting according to the present application.

2. FIG. 3 is picture of an exemplary retroreflective sheeting according to the present application.

3. FIG. 4 is a cross-section of another exemplary retroreflective sheeting according to the present application.

FIG. 5 is a picture of the retroreflective sheeting depicted in FIG. 4.

FIGS. 6(a) and (b) are pictures of an exemplary retroreflective sheeting comprising a marking according to the present application.

FIGS. 7(a) and (b) are pictures of another exemplary retroreflective sheeting comprising a marking according to the present application.

FIGS. 8(a) through (d) are micrographs of exemplary retroreflective sheetings according to the present application.

FIGS. 9(a) through (d) illustrate the top of the optically active volume of deformed cube corner elements according to exemplary retroreflective sheetings of, respectively, FIGS. 8(a) through (d).

FIGS. 10(a) through (d) are scanning electron microscope (SEM) pictures of the cross-section of pairs of cube corner elements.

FIG. 11 illustrates an m by n (m×n) matrix of image elements (pixels) with perceived brightness values x₁-xₙ that collectively form a grayscale marking.

FIG. 12 illustrates three adjacent image elements (pixels) of the m×n matrix depicted in FIG. 11, two of which comprise an array of deformed cube corner elements

FIGS. 13 and 14 are plots of total light return versus percent displaced volume height relative to the original volume height at various entrance and orientation angles.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense.

The retroreflective sheeting of the present application is preferably a cube corner sheeting, sometimes referred to as prismatic sheeting. FIG. 1 depicts a cross-section of a prismatic sheeting of the prior art 100 having a generally planar front surface (i.e., front side) 110, and a structured back surface 120 (i.e., back side) comprising an array of cube corner elements 130. Typically, a cube corner element includes three mutually perpendicular optical faces 132 that intersect at a single apex 134. The faces may be substantially perpendicular to one another (as in the corner of a room) with the apex vertically aligned with the center of the base. The angle between the optical faces typically is the same for each cube corner element in the array and will be about 90 degrees. The angle, however, can deviate from 90 degrees as described, for example, in U.S. Pat. No. 4,775,219 (Appledorn et al), the disclosure of which is incorporated herein by reference. The apex of the cube corner elements may be canted to the center of the base, as disclosed in U.S. Pat. No. 4,588,258 (Hoopman), incorporated herein by reference.

Generally, light that is incident on a corner cube element from a light source is totally internally reflected from each of the three perpendicular cube corner optical faces and is redirected back toward the light source. In use, the retroreflector is arranged with the front side disposed generally toward the anticipated location of intended observers and the light source. Light incident on the front surface enters the sheet and is reflected by each of the three faces of the elements, so as to exit the front surface in a direction substantially toward the light source.

A specular reflective coating or a reflective layer (not shown) may be disposed on the cube corner elements to promote retroreflection. Suitable reflective coatings include metallic coatings (not shown) which can be applied by known techniques such as vapor depositing or chemically depositing a metal such as aluminum, silver, or nickel. Suitable reflective layers include multilayer optical films. A primer layer may be applied to the cube corner elements to promote adhesion of the reflective coating or layer. Alternatively, a sealing film may be used. Exemplary seal films for retroreflective articles are disclosed in U.S. Pat. No. 7,611,251 (Thakkar et al), incorporated herein by reference.

One advantage of the present application is the ability to quickly create and/or modify markings on finished retroreflective sheeting without having to produce new or modify existing tooling. Another advantage of the present application is the ability to tailor optical properties of the retroreflective sheeting and produce articles that meet different ASTM specifications.

Prismatic retroreflective sheeting is known for returning a large portion of the incident light towards the source (Smith, K. Driver-Focused Design of Retroreflective Sheeting For Traffic Signs, in Transportation Research Board 87th Annual Meeting: Compendium of Papers DVD, Washington D.C. 2008). Many commercially available products rely on the relatively high retroreflectivity (light return toward the source) provided by prismatic cube corner microstructures to meet high retroreflectivity specifications (e.g., retroreflectivity (RA) or brightness in the range of 300 to 1000 candela per lux per meter square (cpl) for 0.2 degree observation angle and −4 entrance angle), such as ASTM types III, VII, VIII, IX, and XI, as described in ASTM D 4956-11a.

However, prismatic cube corner microstructures have not typically been used in products designed to meet lower retroreflectivity specifications (e.g., RA in the range of 70 to 250 cpl for 0.2 degree observation angle and −4 entrance angle for white sheeting), such as ASTM types I and II as described in ASTM D 4956-11a. Instead, commercially available ASTM type I and II products typically utilize glass beads embedded in multiple layers of polymeric materials as the optical elements. A specular reflective coating, typically vacuum deposited aluminum, is situated behind the glass beads near the light focal point to enable retroreflection.

One example of a prismatic retroreflective sheeting having controlled retroreflectivity that meets the lower retroreflectivity specifications, such as ASTM types I and II or equivalent worldwide specifications is described in U.S. Patent Publication No. 2010/103521 (Smith et al). In one aspect, the inventors of the present application sought to develop alternative methods to produce lower retroreflectivity prismatic sheeting.

The methods of the present application do not require the production of new or modification of existing tooling, while still maintaining the benefits associated with the microreplication process. In some embodiments of the present application, a majority of cube corner elements in a retroreflective sheeting are at least partially deformed, so that the average retroreflectivity (brightness) of the entire sheeting is reduced. In other embodiments of the present application, cube corner elements are selectively deformed to form markings.

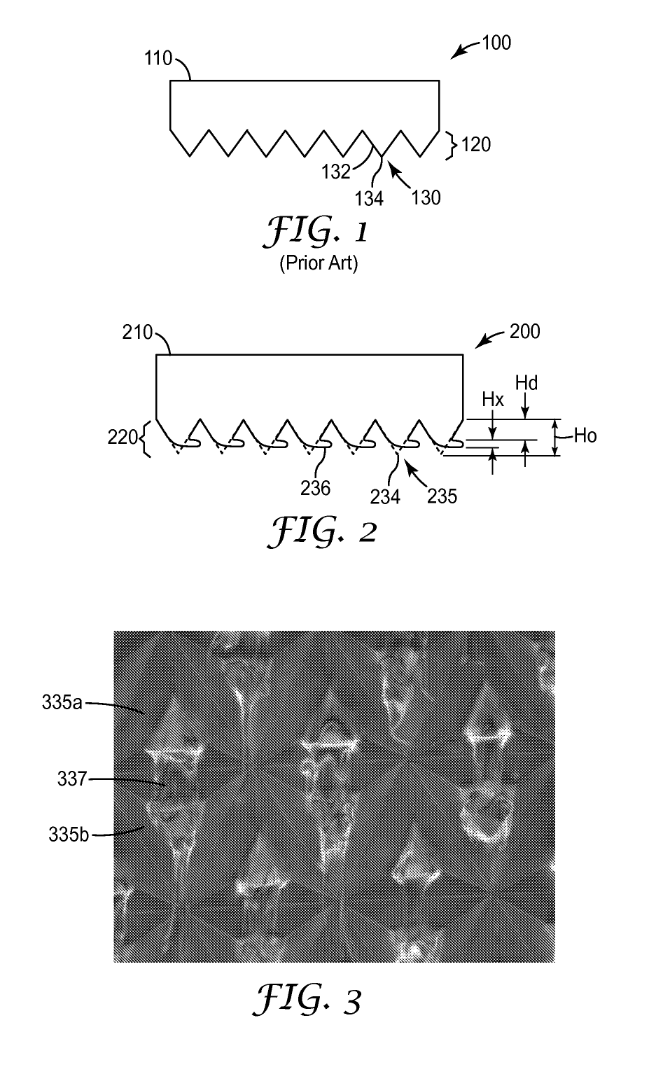

FIG. 2 is a cross-section of an exemplary retroreflective article according to the present application. Prismatic sheeting 200 comprises a generally flat front surface 210 and a structured back surface 220 comprising deformed cube corner elements 235. The original shape of the cube corner elements (i.e., prior to deformation) included three generally perpendicular faces that met at an apex 234 (shown in dotted lines). It is to be understood that “generally perpendicular faces” as used herein is meant to include embodiments in which the angle at which the faces meet slightly deviates from perpendicular, as taught above.

The terms “deforming”, “deformation”, or “deformed” as used herein relate to the modification of the optically active volume of a cube corner element. As used herein “optically active volume” (Vo or Vd) relates to the part or volume of each cube corner element that contributes to retroreflection. Original optically active volume (Vo) relates to the optically active volume of an original cube corner element (i.e., prior to deformation). Original optically active volume (Vo) has a corresponding original active volume height (Ho), shown in FIG. 2. According to the present application, deformation of the cube corner elements is not accomplished by adding material to or removing it from the retroreflective sheeting. In contrast, deformation takes place via displacement of a mass from the tip (apex) of the cube corners (e.g., pyramidal mass), creating a displaced volume (Vx), which does not contribute to retroreflection (i.e., is optically inactive). As a result, a deformed cube corner element has a reduced optically active volume (Vd) and a reduced active volume height (Hd), also shown in FIG. 2. As used herein, the term “displaced volume” (Vx) relates to the displaced portion 236 of a deformed cube corner element that does not contribute to retroreflection (i.e., is optically inactive). Displaced volume height (Hx) is the height of the displaced volume (Vx), as shown in FIG. 2, and may be expressed as a percentage of the original volume height (Ho). For example, an Hx of 10% means that Hx is equal to 10% of the original volume height. Optical properties (e.g., retroreflectivity (RA)) of the deformed cube corner elements 235 are different from the optical properties of the original (non-deformed) elements.

Retroreflectivity of a prismatic sheeting according to the present application may be modified depending on (i) the number of deformed cube corner elements; and/or (ii) the extent to which the cube corner elements are deformed. In some embodiments, attenuation of total light return (TLR) across a large area of reflective sheeting is accomplished by deforming a majority of cube corner elements in the retroreflective sheeting. In some embodiments, at least 30% of cube corner elements are deformed. In other embodiments, at least 50% of the cube corner elements are deformed. In other embodiments, at least 60% of the cube corner elements are deformed. In other embodiments, at least 70% of the cube corner elements are deformed. In yet other embodiments, at least 80% of the cube corner elements are deformed.

The extent to which a cube corner element is deformed may vary. In some instances, only a small portion of the apex of a cube corner element is deformed (e.g., reduced active volume height (Hd) corresponds to from about 85% to about 99% of the original cube height (Ho)). In other instances, deformation may extend further down the cube corner structure with reduced active volume height (Hd) corresponding to from about 50% to about 85% of original cube height (Ho). In some embodiments, cube corner elements may be totally deformed (e.g., reduced active volume height corresponds to about 0% of the original cube height). Retroreflectivity of the deformed cube corner element is dependent on the reduced optically active volume and reduced active volume height. The more Hd approaches Ho, the greater the retroreflectivity of the deformed cube corner element as it approaches the retroreflectivity of the original cube corner element.

In some embodiments, a bridge of cube corner material is formed between adjacent deformed cube corner elements, such as shown in FIG. 3. In this embodiment, deformed cube corner elements are prepared as matched pairs 335a and 335b, as described in U.S. Pat. No. 4,588,258 (Hoopman), the disclosure of which is incorporated herein by reference. Depending, for example, on the method being used and the orientation at which the retroreflective sheeting is moved (if moved) when deformation occurs (e.g., moving in the longitudinal direction (i.e., direction along the article's length)), the bridge 337 is formed between a matched pair of cube corner elements, as shown in FIG. 3. Alternatively, a bridge may be formed between adjacent, but not matched, deformed cube corner elements

FIG. 4 is a cross-section of another exemplary retroreflective article according to the present application. Prismatic sheeting 400 has a generally flat front surface 410 and a structured surface 420, opposite flat surface 410. Structured surface 420 comprises original cube corner elements 430, deformed cube corner elements 435, and a metallic coating 460, adjacent cube corner elements 430, 435. In this embodiment, deformed cube corner elements 435 were thermally deformed. Heat was applied to the cube corner elements, causing the underlying cube corner elements to melt and/or soften. As a result, the metallic coating was deformed, torn, and/or removed from the deformed cube corner elements 435, leaving portions of the cube corner element exposed 435c. Adhesive layer 470 is optionally used to secure retroreflective article 400 to a substrate (not shown). When the adhesive layer 470 is used, exposed portions of the deformed cube corner element 435c are brought into contact with the adhesive layer 470, and retroreflection is frustrated (i.e., exposed portions are rendered optically inactive).

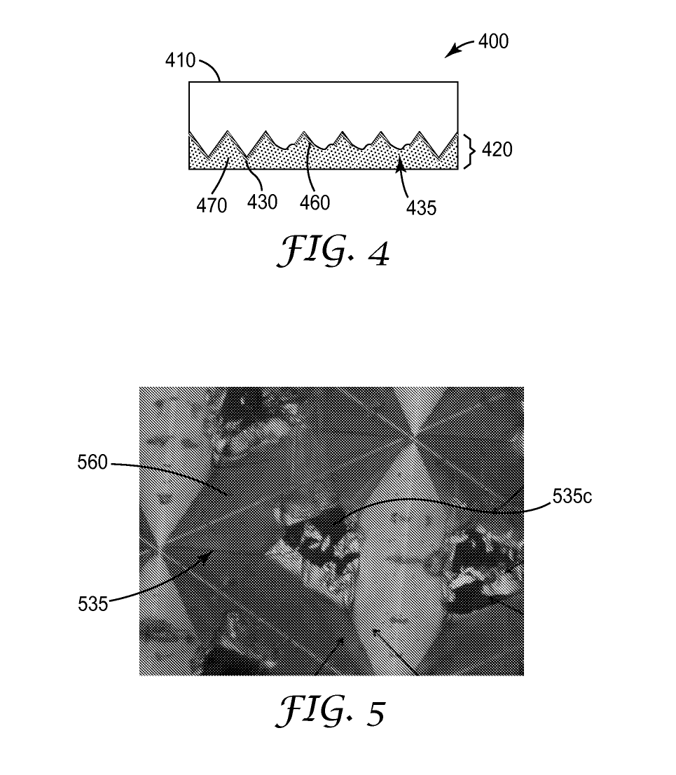

FIG. 5 is a picture of the retroreflective sheeting depicted in FIG. 4, and prepared as described in Example 2 below. Metallic coating 560 has torn, deformed, and moved from the apex of deformed cube corner element 535, leaving portions of the element exposed 535c.

Some embodiments of the present application relate to retroreflective sheeting comprising an array of deformed cube corner elements that exhibits an average brightness at 0 deg. and 90 deg. orientation according to ASTM D4596-09 of between about 70 candelas/lux/m² and about 250 candelas/lux/m² for an entrance angle of −4 deg. and an observation angle of 0.2 deg. wherein the sheeting has a color that is one of white or silver.

In another aspect, the inventors of the present application sought to selectively deform cube corner elements, creating patterns (markings) discernible at different viewing conditions (e.g., illumination conditions, observation angle, entrance angle). In some embodiments, the markings may be used for decorative purposes and may form, for example, an image or a logo. In other embodiments, the markings may be used as identifying indicia, allowing the end user to identify, for example, the manufacturer and/or lot number of the retroreflective article. In yet other embodiments, the markings may be used as security marks, which are preferably difficult to copy by hand and/or by machine or are manufactured using secure and/or difficult to obtain materials. Retroreflective sheeting with security markings may be used in a variety of applications such as securing tamperproof images in security documents, passports, identification cards, financial transaction cards (e.g., credit cards), license plates, or other signage. The security marking can change appearance to a viewer as the viewer changes illumination conditions and/or their point of view of the security mark. The security mark can be any useful mark including a shape, figure, symbol, quick response (QR) code, design, letter, number, alphanumeric character, and indicia, for example.

Beaded sheeting having specific graphic images or marks has been used on license plates to act as a means of verifying the authenticity or valid issuance of the license plate. A security mark for use on license plates using beaded sheeting is described, for example, in U.S. Pat. No. 7,068,434 (Florczak et. al.). This security mark is formed in beaded sheeting as a composite image that appears to be suspended above or below the sheeting. Because of its appearance, this type of security mark is generally referred to as a floating image.

A prismatic retroreflective sheeting comprising identifying indicia is described, for example, in U.S. Pat. No. 8,177,374 (Wu), wherein planar disturbances are formed on selected faces of a tooling plate, collectively forming the identifying indicia. Retroreflective sheeting made using the modified tooling plate comprises identifying indicia corresponding to the inverse of the planar disturbance of the tooling plate. One disadvantage of the method described in Wu relates to the ease and cost of manufacturing. Tooling plates are difficult and expensive to produce. In addition, when a modification to the identifying indicia is desired, production of a new modified tooling plate is required. Therefore formation of markings in retroreflective sheeting that do not require making new or modifying existing tooling plates is desirable.

As described above, one advantage of the present application is the ability to create markings on finished retroreflective sheeting without having to produce new or modify existing tooling. Another advantage of the present application is the ease and speed at which the markings may be modified, thus allowing customization of the marking according to its intended use. In one aspect, the present application relates to selectively deforming (e.g., by selectively applying heat to) cube corner elements. The amount of heat and pressure applied to the structured surface of the retroreflective sheeting will depend on the intended cube corner element deformation. Generally, higher temperatures and/or higher pressures produce larger deformation resulting in greater reduced optically active volume (Vd) and reduced active volume height (Hd). The methods of the present application allow for controlled deformation of adjacent cube corner elements. As used herein, “controlled deformation” or “controllably deforming” are intended to mean varying reduced optically active volume and reduced active volume height across different cube corner elements. For example, a first cube corner element may have a first reduced optically active volume (Vd1) and reduced active volume height (Hd1), and a second cube corner element, originally having the same volume and height of the first cube corner element, may have a second reduced optically active volume (Vd2) and reduced active volume height (Hd2). In some embodiments, Vd1 and Hd1 are larger than, respectively, Vd2 and Hd2, when expressed as a percentage of the original optically active volume Vo and original optically active height Ho. In these embodiments, the first cube corner element has higher retroreflectivity than the second cube corner element. As a result, the second cube corner element appears darker under retroreflective conditions than the first cube corner element. Under ambient diffuse conditions, the second cube corner element diffuses (scatters) more light than the first cube corner element, thus appearing brighter.

In some embodiments, it is desirable to produce complex markings having positional variations in reflectivity, such as, for example, reproducing an image with shadows and/or hue variation. Such markings could be aligned with (e.g., provided in registration with) printed graphic images on the front side of the sheeting to produce graphic images with enhanced contrast. Such patterns are not only aesthetically pleasing, but also particularly useful in forming security markings due to their difficulty to be copied.

One advantage of the present method is the ability to create such complex markings using grayscale markings, produced by controllably deforming cube corner elements. The term “grayscale” as used herein means composed of shades of gray, each shade defined by a grayscale value varying from black (0) to white (2ⁿ−1, wherein n is the bit depth of an image). For example, an 8-bit grayscale image has 256 gray levels ranging from 0 (black) to 255 (white). Typically, a mathematical function (image gamma-correcting function) is used to map grayscale values to a target gray (lightness or brightness) value. Grayscale images are particularly useful in the rendering, displaying, or printing of photographic images.

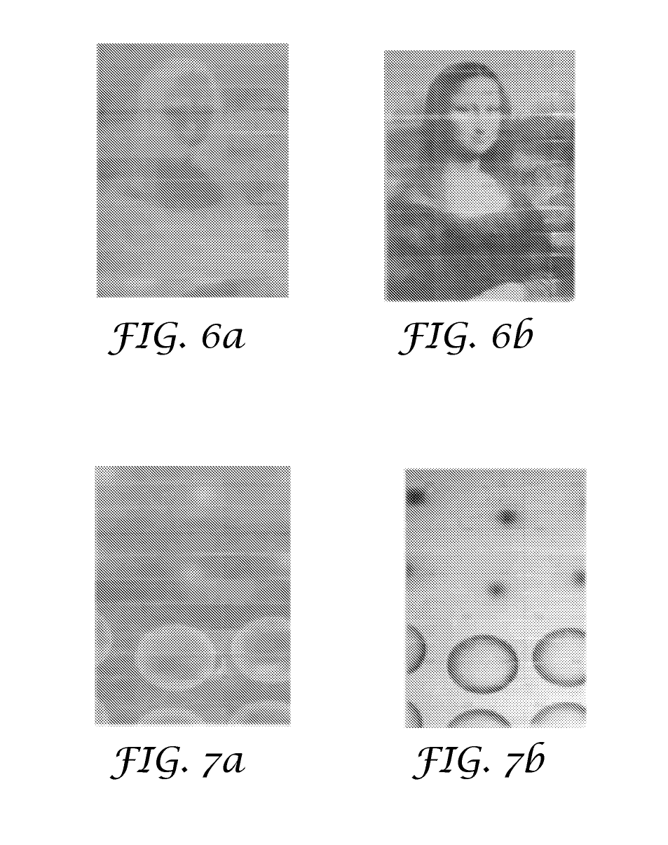

FIGS. 6(a) and 6(b) are pictures of a complex marking on a retroreflective sheeting according to the present application and prepared as described in Example 3 below. The complex marking consisted of a grayscale image of the Mona Lisa, by Leonardo da Vinci. FIG. 6(a) is a digital photograph taken under diffuse visible light conditions. FIG. 6(b) is a digital photograph taken under visible retroreflective conditions, using a flashlight and the digital camera. A higher heat setting was used to create Mona Lisa's hair and clothes and as a result, they appear brighter under diffuse visible conditions. As explained above, deformed cube corner elements exposed to higher temperatures have a more reduced optically active volume and active volume height than those of the original (i.e., prior to deformation) cube corner element.

FIGS. 7(a) and (b) are pictures of another complex marking on a retroreflective sheeting, according to the present application and prepared as described in Example 4 below. A pattern with four rows of spheres with varying shading was used. The amount of heat applied varied depending on the desired retroreflective brightness. FIG. 7(a) is a digital photograph of the retroreflective sheeting of Example 4 taken under diffuse visible conditions. FIG. 7(b) is a digital photograph of the retroreflective sheeting of Example 4 taken under retroreflective conditions. Similarly to FIGS. 6(a) and (b), deformed cube corner elements subjected to higher temperatures appear brighter under diffuse conditions (e.g., the outline of the spheres of the top two rows and the center of the spheres of the bottom two rows), whereas deformed cube corner elements subjected to lower temperatures were deformed to a lesser extent and thus appear brighter under retroreflective conditions.

In some embodiments, cube corner elements are thermally deformed (i.e., by application of heat). Particularly, thermally deformed cube corner elements may be one of, for example, thermomechanically deformed and thermally sheared. In other embodiments deformation is accomplished by having cube corner elements include a radiation absorber (e g, infrared absorber), wherein such cube corner elements absorb light when submitted to specific wavelengths. A radiation absorber may be added to a portion of the cube corner element, such as, for example, to the apex. Other suitable methods for deforming cube corner elements include thermomechanical deformation using, for example, one of an ultrasonic welder and a stamper. Ultrasonic welders press the substrate to be deformed between a tool and a backup plate, wherein the tool and/or plate may be rotary tools. Ultrasonic energy is then applied to the tool through an ultrasonic horn causing the tool to vibrate, producing heat due to the friction between the horn and the substrate. A stamper, on the other hand, is heated and pressed into the surface of the substrate.

A thermal printer may be used to thermally deform a portion of at least one cube corner element. In this embodiment, deformation occurs as thermal shearing of the cube corner elements. Thermal shearing occurs when a heated resistive thermal printer element and one or more cube corner elements are brought into contact with one another and the relative motion is linear in a plane parallel to the sheet. The result is a thermal shearing of a portion of the cube corner element, producing an optically active volume with a relatively flat top, and a displaced volume.

Typically, thermal printers are digital printing devices that use a print head with a linear array of addressable heating elements. An image is formed by moving a substrate to be printed under the print head at a certain rate, while the heating elements are thermally modulated to affect the printing process. Image data comprises information for an m and n array of picture elements (pixels) and a grayscale value for each element. The grayscale value determines the time, thermal profile, and temperature of each addressable heating element. Thermal printers have controlled heat pulse which may be adjusted depending on the amount of heat intended to be delivered to the substrate (e.g., retroreflective sheeting). The baseline value of the grayscale markings may be adjusted through, for example, the equipment's power setting.

Commercially available thermal printers may be used in different modes to thermally shear cube corner elements. One exemplary mode is known as direct write mode, and does not make use of a donor film (which is typically used to transfer a pigmented material to a substrate). Rather, direct write mode uses the thermal elements to directly apply heat to the surface of a substrate.

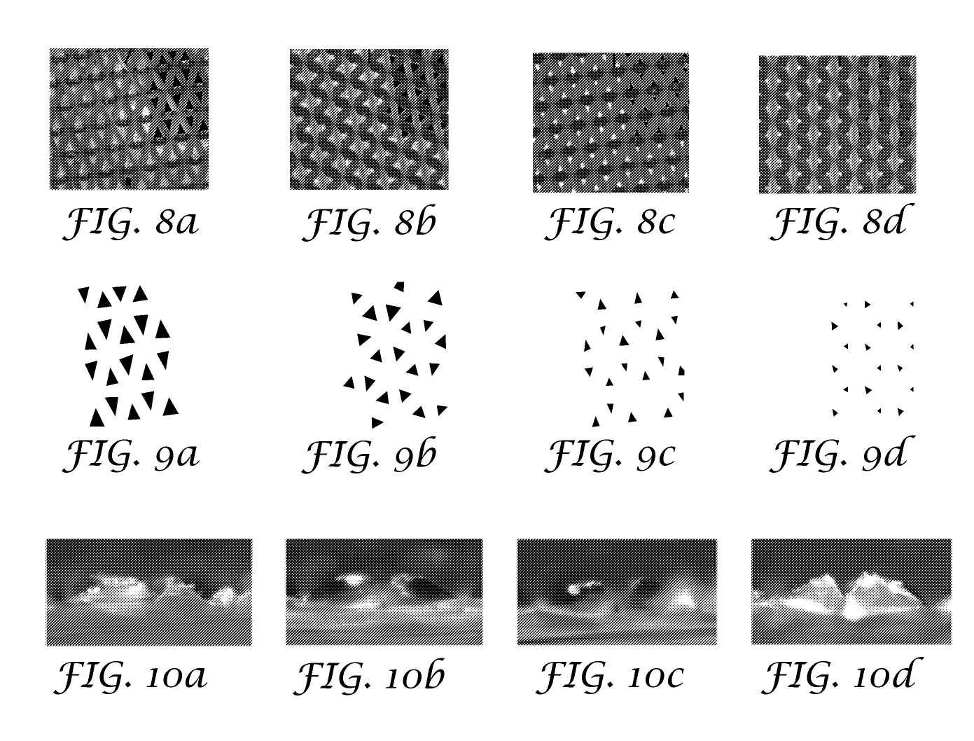

FIGS. 8(a), (b), (c) and (d) are micrographs of exemplary retroreflective sheetings according to the present application. FIGS. 9(a), (b), (c), and (d) depict the top of reduced optically active volumes of deformed cube corner elements according to of retroreflective sheetings shown in, respectively, FIGS. 8(a), (b), (c) and (d). Cube corner elements of the retroreflective sheetings shown in FIGS. 8(a)-(d) were thermally deformed using a thermal printer. In the retroreflective sheeting shown in FIG. 8(a), the thermal printer was set to a darkness level of 5, with the print darkness adjust potentiometer set to the maximum level. Retroreflectivity at an entrance angle of −4° and observation angle of 2° was about 130 cd/lux/m². FIG. 9(a) depicts the top of the reduced optically active volume of each deformed cube corner element of the sheeting shown in FIG. 8(a). In the retroreflective sheeting shown in FIG. 8(b) the thermal printer was set to a darkness level of 4, with the print darkness adjust potentiometer set to the maximum level. Retroreflectivity at an entrance angle of −4° and observation angle of 2° was about 310 cd/lux/m². FIG. 9(b) depicts the top of the reduced optically active volume of each deformed cube corner element of the sheeting shown in FIG. 8(b). In the retroreflective sheeting shown in FIG. 8(c) the thermal printer was set to a darkness level of 3, with the print darkness adjust potentiometer set to the maximum level. Retroreflectivity at an entrance angle of −4° and observation angle of 2° was about 580 cd/lux/m². FIG. 9(d) depicts the top of the reduced optically active volume of each deformed cube corner element of the sheeting shown in FIG. 8(c). In the retroreflective sheeting shown in FIG. 8(d) the thermal printer was set to a darkness level of 2, with the print darkness adjust potentiometer set to the maximum level. Retroreflectivity at an entrance angle of −4° and observation angle of 2° was about 850 cd/lux/m². FIG. 9(d) depicts the top of the reduced optically active volume of each deformed cube corner element of the sheeting shown FIG. 8(d).

Exemplary polymers for forming cube corner elements include thermoplastic polymers, such as, for example, poly(carbonate), poly(methylmethacrylate), poly(ethyleneterephthalate), aliphatic polyurethanes, as well as ethylene copolymers and ionomers thereof, and mixtures thereof. Cube corner sheeting may be prepared by casting directly onto a film, such as described in U.S. Pat. No. 5,691,846 (Benson). Polymers for radiation cured cube corners include cross linked acrylates such as multifunctional acrylates or epoxies and acrylated urethanes blended with mono- and multifunctional monomers. Further, cube corners such as those previously described may be cast on to plasticized polyvinyl chloride film for more flexible cast cube corner sheeting. These polymers are preferred for one or more reasons including thermal stability, environmental stability, clarity, excellent release from the tooling or mold, and capability of receiving a reflective coating. Thermoplastic polymers are particularly useful when heat is used to deform cube corner elements.

Prismatic retroreflective sheeting can be manufactured as an integral material, e.g., by embossing a preformed sheet with an array of cube corner elements or by casting a fluid material into a mold. Alternatively, retroreflective sheeting can be manufactured as a layered product by casting the cube corner elements against a preformed film or by laminating a preformed film to preformed cube corner elements. The cube corner elements can be formed on a polycarbonate film approximately 0.5 mm thick having an index of refraction of about 1.59. Useful materials for making retroreflective sheeting are preferably materials that are dimensionally stable, durable, weatherable, and readily formable into the desired configuration. Generally any optically transmissive material that is formable, typically under heat and pressure, can be used.

The sheeting can also include colorants, dyes, UV absorbers or separate UV absorbing layers, and other additives as needed. A backing layer sealing (i.e., sealing film) the cube corner elements from contaminants can also be used, together with an adhesive layer.

In some embodiments, cube corner elements are deformed through the sealing film. Alternatively, cube corner elements may be deformed through a multilayer construction including at least two of a sealing film, an adhesive layer, and a release film, or any combinations thereof.

FIGS. 10(a), (b), (c), and (d) are SEM pictures of cross-sections of pairs of cube corner elements. FIG. 10(d) shows a pair of original cube corner elements (i.e., not deformed). Retroreflectivity of the original cube corner element was measured as about 1100 can/lux/m². FIGS. 10(a), (b) and (c) each show a pair of deformed cube corner elements according to the present application. As it may be seen, the apex of each cube corner element shown has been thermally sheared, resulting in a reduction in the optically active volumes and consequently, in retroreflectivity. Thermally sheared cube corner elements shown in FIGS. 10(a), (b) and (c) had a measured retroreflectivity of, respectively, about 30 can/lux/m², 400 can/lux/m² and 920 can/lux/m².

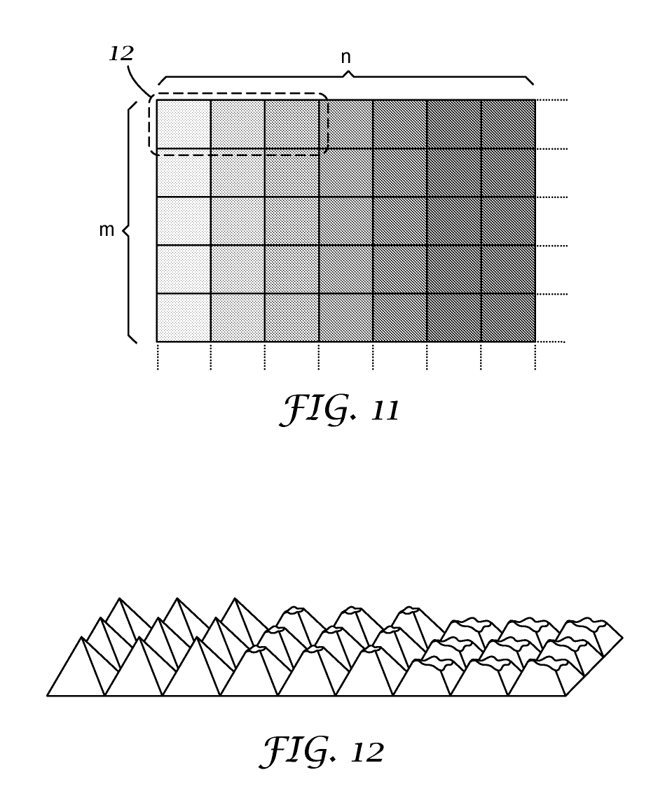

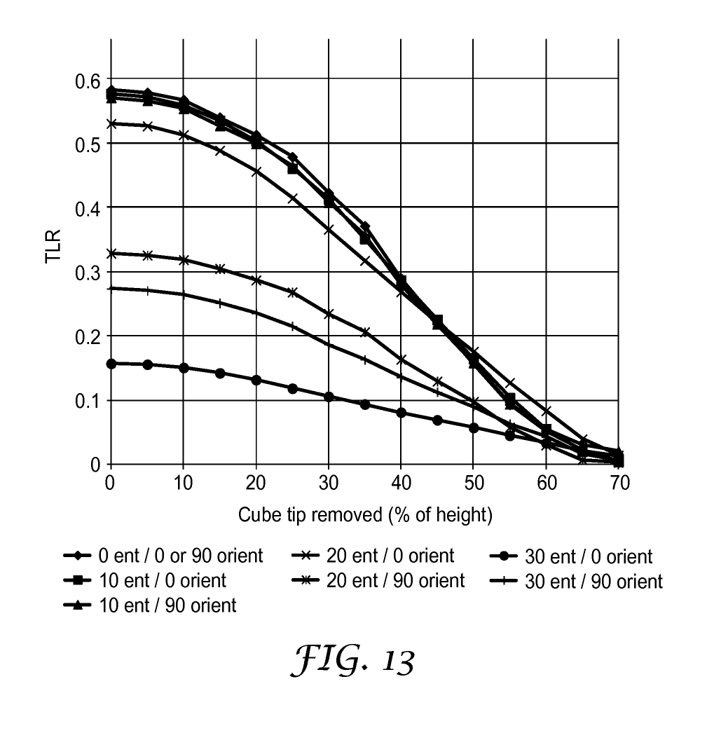

The present application describes retroreflective grayscale images comprising a regular array of an image or picture elements (pixels) with m rows and n columns, as shown in FIGS. 11 and 12. Each pixel further comprises one or more cube corner elements, wherein cube corner elements in a given pixel have similar optically active volumes and active volume heights. FIG. 12 illustrates three adjacent image elements (pixels) of the m×n matrix depicted in FIG. 11. Each pixel is depicted as having 3 rows of cubes, each row further comprising 3 cubes with the same geometry, for a total of 9 same-geometry-cubes per pixel. It is to be understood that the number of cubes depicted is a mere illustration of the present application, and more or less cube corner elements may be present in each pixel. In addition, the format for each pixel may vary. In some embodiments, the shape of each pixel is selected from the group consisting of square, circular, triangular, rectangular, hexagonal, and combinations thereof. Each pixel depicted in FIG. 12 has perceived brightness values ranging from x1-x3 that collectively form a grayscale marking.

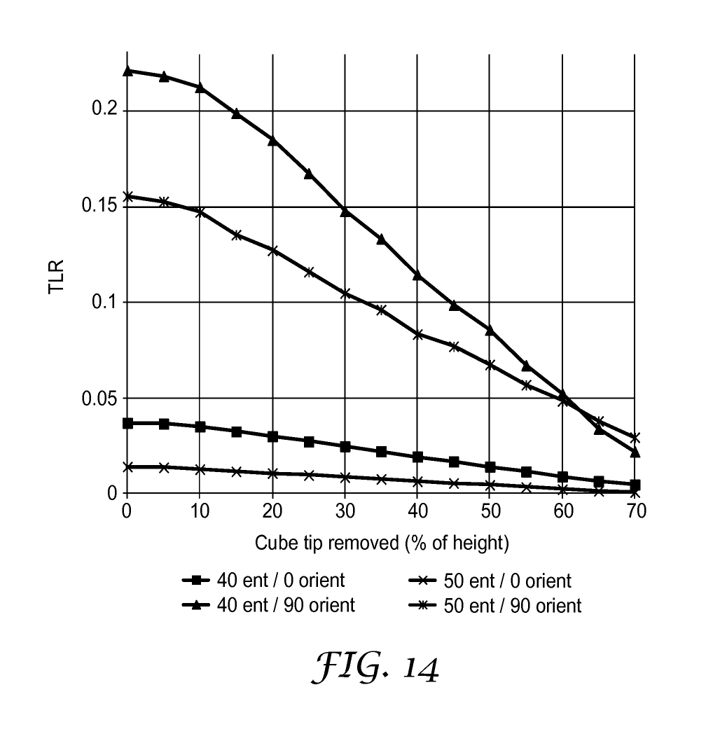

TLR values of each pixel can be calculated based on the principles of geometric optics and ray tracing. FIGS. 13 and 14 illustrate calculated TLR versus percent displaced volume height (Hx) for an exemplary retroreflective sheeting at entrance angles of about 0, 10, 20, 30, 40 and 50 degrees and orientations of about 0 and 90 degrees. Modeling was performed by entering data in a computer software to construct a 3D model of desired cube corner elements. Truncated cube corner elements having included angles of 58, 58 and 64 degrees and made of a material having a refractive index of about 1.5 were generated.

Deformed cube corner elements were constructed as having an additional facet formed by the deformation of the apex of the cube corner element. In this exemplary embodiment, the additional facet was considered parallel to the base of the truncated cube corner element. It is to be understood that according to the present application, the additional facet need not be parallel to the base. The distance between the additional facet and the base plane of the cube corner element is the active volume height (Ho or Hd). The height of the deformed cube corner element was reduced from its original height by an amount defined as the fractional reduction in active volume height, or alternatively, displaced volume height. The paths taken by a series of rays (covering the entire area of the base of the cube corner element) were calculated.

Calculation included the effects of reflection at each of the cube facets (whether complete reflection due to Total Internal Reflection or partial reflection due to striking a facet at an angle smaller than the critical angle). The total flux of all rays which reflect off all three facets contained within the optically active volume of the cube corner element (and which thus experience retroreflection) was divided by the total starting flux incident upon the cube corner element to determine the Total Light Return (TLR) for this cube corner element. This TLR calculation was repeated for the matched cube corner element contained within the cube corner array (identical to the previous cube corner element, but rotated 180 degrees about an axis perpendicular to the base plane of the cube corner element array). These two TLR values were averaged to determine the average TLR for the cube corner array at the particular entrance and orientation angle under consideration. This calculation was repeated for increasing fractional reduction in active volume height values (representing decreasing cube corner heights). This entire calculation procedure was repeated for other entrance and orientation angles of interest.

Original cube corner elements (i.e., having no displaced volume height) of this design were calculated to have a TLR of about 58% (return of the incident light) for a 0 degree entrance angle and 0 degree orientation. This TLR value corresponding to white in a grayscale value of (2ⁿ−1), wherein n is the bit depth of the image. TLR for deformed cube corner elements having a displaced volume height corresponding to about 70% of the original volume height was calculated as about 3%. This TLR value would correspond to black, and a grayscale value of 0. Intermediate grayscale values are subsequently determined mathematically using a possibly non-linear image gamma-adjusting function, which assigns more data values to midtone regions of the grayscale curve, where human vision can discriminate grayscale values more readily.

In one embodiment of the present application, the number of cube corner elements per pixel (z) is determined by the ratio of the cube corner pitch (P_{c}) and the printer pitch (Pₚ). For square pixels, the number of cube corner elements may be calculated using the equation: z=(Pₚ)²/(P_{c})². Typically, commercially available resistive thermal printers have dot (addressable) resolution between 150 and 300 pixels per inch (ppi), corresponding to dot pitches of 169 microns and 85 microns, respectively. Retroreflective sheeting used in the Examples, below, has a cube corner element pitch of 4 mil (100 microns). Consequently, using a 150 ppi printer results in images with approximately 3 cube corner elements per pixel.

In another embodiment, the printer pitch may comprise multiple addressable printer elements as one large meta-pixel. This embodiment is particularly useful for producing large format grayscale images.

In the present application, it is not necessary to align the print head and the retroreflective sheeting. Therefore, pixels on the sheeting may be rotated or translated with respect to the pattern of cube corners. Pixels may comprise original and deformed cube corner elements. There may also be original cube corner elements corresponding to regions between thermal resistive elements on the printer.

In some embodiments, each pixel comprises a large number of cube corner elements (e.g., greater than 100). In such embodiments, spatial modulation techniques such as half-toning and mid-toning may be used to create an effective grayscale value. In one example, spatial modulation is based on the spatial averaging of original cube corner elements (i.e., having a displaced volume height (Hx) of 0%) and completely deformed retroreflective cube corners (displaced volume height (Hx) of 100%). A range of TLR values is determined by the number of each cube corner element within a single pixel. Use of spatial modulation techniques allows for incorporation of printing technologies such as half-toning with regular or stochastic dot patterning.

The present application may also be used to minimize the contrast created by seam welds, tiling lines and/or defects on a retroreflective sheeting. Seam welds, tiling lines, and/or defects typically comprise cube corner elements which appear darker than the surrounding area under retroreflective conditions. One method to minimize the optical effect of these darker areas on a otherwise bright retroreflective article is by controllably deforming cube corner elements near the seam/tiling line, selectively reducing optically active volumes of neighboring cube corner elements, creating a retroreflectivity gradient. The gradient near the darker areas could soften their appearance, making them less obvious. Additionally, the deleterious effects of the dark areas on the appearance of the retroreflective sheeting can be minimized by controllably deforming cube corner elements everywhere on the sheeting except near the dark areas, thus reducing the variability in retroreflective brightness of the sheeting by reducing the average retroreflective brightness of the sheeting.

One advantage of the methods of the present application relate to the ability of tailoring optical properties of a retroreflective article by modifying conventional retroreflective sheeting. An exemplary method according to the present application includes obtaining a retroreflective sheeting having a flat major surface and a structured surface, opposite the flat major surface, the structured surface comprising cube corner elements having three mutually perpendicular faces that meet at an apex, and thermally deforming the apices of at least a portion of the cube corner elements. In some embodiments, less than 5% of the original cube height is deformed. In other embodiments, less than 10% of the original cube height is deformed. In yet other embodiments, less than 15% of the original cube height is deformed.

In another embodiment, an exemplary method of forming retroreflective sheeting includes obtaining a retroreflective sheeting having a flat major surface and a structured surface, opposite the flat major surface, the structured surface comprising cube corner elements having three mutually perpendicular faces that meet at an apex and a reflective layer disposed on the cube corner elements, and applying heat to at last a portion of the cube corner elements, wherein at least a portion of the cube corner apices, wherein the reflective layer of the heated cube corner elements is deformed. The reflective layer may deform, tear, or become displaced. As a result, a portion of the underlying cube corner element may become exposed. In some embodiments, the reflective layer is a metallic coating. In other embodiments, the reflective layer is a multilayer optical film.

The term “sheeting” generally refers to articles which have a thickness on the order of about 1 mm or less and which in large samples can be wound tightly into a roll for ease of transportation.

The retroreflective sheeting articles can be utilized in signage and license plate articles.

Exemplary embodiments of the present application include, but are not limited to, the embodiments described below.

In a first embodiment, the present application relates to a retroreflective sheeting comprising: a structured surface including cube corner elements having three generally perpendicular faces that meet at an apex; wherein the apex of at least 30 percent of the cube corner elements is thermally deformed, resulting in deformed cube corner elements.

In a second embodiment, the present application relates to the retroreflective sheeting of embodiment 1, wherein deformed cube corner elements have a displaced active volume height of at least 1 percent.

In a third embodiment, the present application relates to the retroreflective sheeting of embodiment 2, wherein the displaced active volume height is at least 5 percent.

In a fourth embodiment, the present application relates to the retroreflective sheeting of embodiment 1, further comprising a reflective layer adjacent the cube corner elements.

In a fifth embodiment, the present application relates to the retroreflective sheeting of embodiment 4, wherein the reflective layer is one of a metallic coating and a multilayer optical film.

In a sixth embodiment, the present application relates to the retroreflective sheeting of embodiment 1, wherein the deformed cube corner elements comprise a thermoplastic polymer.

In a seventh embodiment, the present application relates to the retroreflective sheeting of embodiment 6, wherein the thermoplastic polymer is one of poly(carbonate), poly(methylmethacrylate), poly(ethyleneterephthalate), polyurethane, ethylene copolymers and ionomers thereof, and mixtures thereof.

In an eighth embodiment, the present application relates to a retroreflective sheeting as in one of embodiments 6 and 7, further comprising a thermoplastic bridge between two adjacent deformed cube corner elements.

In a ninth embodiment, the present application relates to the retroreflective sheeting of embodiment 1, wherein least 50 percent of the cube corner elements are thermally deformed cube corner elements.

In a tenth embodiment, the present application relates to the retroreflective sheeting of embodiment 1, wherein the average coefficient of retroreflection of the deformed cube corner elements at 0 deg. and 90 deg. orientation according to ASTM D4596-09 is between about 70 candelas/lux/m² and about 250 candelas/lux/m² for an entrance angle of −4 deg. and an observation angle of 0.2 deg., wherein the sheeting has a color that is one of white or silver.

In an eleventh embodiment, the present application relates to the retroreflective sheeting of embodiment 1, wherein the deformed cube corner elements form a marking.

In a twelfth embodiment, the present application relates to the retroreflective sheeting of embodiment 11, wherein the marking is a grayscale marking.

In a thirteenth embodiment, the present application relates to a retroreflective sheeting as in one of embodiments 11 and 12, wherein the marking forms a security mark.

In a fourteenth embodiment, the present application relates to the retroreflective sheeting of embodiment 13, wherein the security mark is one of a shape, figure, symbol, design, letter, number, bar code, QR code, alphanumeric character, and indicia.

In a fifteenth embodiment, the present application relates to a retroreflective sheeting comprising: a structured surface including cube corner elements, wherein at least some of the cube corner elements are thermally sheared; and wherein the thermally sheared cube corner elements form a grayscale marking.

In a sixteenth embodiment, the present application relates to the retroreflective sheeting of embodiment 15, wherein the grayscale marking further includes: a first pixel comprising a first plurality of deformed cube corner elements having a first reduced optically active volume; and a second pixel comprising a second plurality of deformed cube corner elements having a second reduced optically active volume, different from the first reduced optically active volume.

In a seventeenth embodiment, the present application relates to a retroreflective sheeting as in one of embodiments 15 and 16, wherein the grayscale marking is one of a graphic and photographic image.

In an eighteenth embodiment, the present application relates to the retroreflective sheeting of embodiment 15, wherein the grayscale marking forms a security mark.

In a nineteenth embodiment, the present application relates to the retroreflective sheeting of embodiment 18, wherein the security mark is one of a shape, figure, symbol, design, letter, number, bar code, QR code, alphanumeric character, and indicia.

In a twentieth embodiment, the present application relates to the retroreflective sheeting of embodiment 15, wherein the cube corner elements comprise a thermoplastic polymer.

In a twenty-first embodiment, the present application relates to the retroreflective sheeting of embodiment 20, wherein the thermoplastic polymer is one of poly(carbonate), poly(methylmethacrylate), poly(ethyleneterephthalate), polyurethane, ethylene copolymers and ionomers thereof, and mixtures thereof.

In a twenty-second embodiment, the present application relates to the retroreflective sheeting of embodiment 15, wherein the thermally sheared cube corner elements have a reduced optically active volume of at least 50 percent.

In a twenty-third embodiment, the present application relates to the retroreflective sheeting of embodiment 22, wherein the reduced optically active volume is at least 70 percent.

In a twenty-fourth embodiment, the present application relates the retroreflective sheeting of embodiment 15, further comprising a reflective layer adjacent the cube corner elements.

In a twenty-fifth embodiment, the present application relates to the retroreflective sheeting of embodiment 24, wherein the reflective layer is one of a metallic coating and a multilayer optical film.

In a twenty-sixth embodiment, the present application relates to a retroreflective sheeting comprising: a structured surface including an array of deformed cube corner elements having reduced optically active volumes, the array comprising multiple pixels, a first pixel comprising cube corner elements having a first total light return value and a second pixel, adjacent to the first pixel, comprising cube corner elements having a second total light return value, different from the first value.

In a twenty-seventh embodiment, the present application relates to the retroreflective sheeting of embodiment 26, wherein the first and second pixels form a marking.

In a twenty-eighth embodiment, the present application relates to the retroreflective sheeting of embodiment 27, wherein the marking is a grayscale marking.

In a twenty ninth embodiment, the present application relates to a retroreflective sheeting as in one of embodiments 27 and 28, wherein the marking forms a security mark.

In a thirtieth embodiment, the present application relates to the retroreflective sheeting of embodiment 29, wherein the security mark is one of a shape, figure, symbol, design, letter, number, bar code, QR code, alphanumeric character, and indicia.

In a thirty-first embodiment, the present application relates to the retroreflective sheeting of embodiment 26, wherein the cube corner elements comprise a thermoplastic polymer.

In a thirty-second embodiment, the present application relates to the retroreflective sheeting of embodiment 31, wherein the thermoplastic polymer is one of poly(carbonate), poly(methylmethacrylate), poly(ethyleneterephthalate), polyurethane, ethylene copolymers and ionomers thereof, and mixtures thereof.

In a thirty-third embodiment, the present application relates to a method of making a retroreflective article comprising: obtaining a retroreflective sheeting having a structured surface comprising cube corner elements having three generally perpendicular faces that meet at an apex; thermally deforming the apex of at least 30 percent of the cube corner elements.

In a thirty-fourth embodiment, the present application relates to the method of embodiment 33, wherein the cube corner elements further comprise a reflective layer.

In a thirty-fifth embodiment, the present application relates to the method of embodiment 34, wherein the reflective layer is one of a metallic coating and a multilayer optical film.

In a thirty-sixth embodiment, the present application relates to the method of embodiment 33, wherein the cube corner elements comprise a thermoplastic polymer.

In a thirty-seventh embodiment, the present application relates to the method of embodiment 36, wherein the thermoplastic polymer is one of poly(carbonate), poly(methylmethacrylate), poly(ethyleneterephthalate), polyurethane, ethylene copolymers and ionomers thereof, and mixtures thereof.

In a thirty-eighth embodiment, the present application relates to the method of embodiment 33, wherein the cube corner elements are thermally deformed using at least one of a thermal printer, ultrasonic welder and hot stamper.

In a thirty-ninth embodiment, the present application relates to the method of embodiment 38, the cube corner elements are thermally deformed using a thermal printer.

In a fortieth embodiment, the present application relates to the method of embodiment 39, wherein the thermal printer is set to direct writing mode.

In a forty-first embodiment, the present application relates to the method of embodiment 33, wherein the thermally deformed cube corner elements form a marking.

In a forty-second embodiment, the present application relates to the method of embodiment 41, wherein the marking is a grayscale pattern.

In a forty-third embodiment, the present application relates to a method as in one of embodiments 41 and 42, wherein the marking forms a security mark.

In a forty-fourth embodiment, the present application relates to the method of embodiment 43, wherein the security mark is one of a shape, figure, symbol, design, letter, QR code, number, alphanumeric character, and indicia bar codes.

In a forty-fifth embodiment, the present application relates to the method of embodiment 42, wherein the grayscale marking is created using spatial modulation.

In a forty-sixth embodiment, the present application relates to a method of making a retroreflective article comprising: obtaining a retroreflective sheeting having a structured surface comprising a plurality of cube corner elements; thermally shearing at least some of the cube corner elements; wherein the thermally sheared cube corner elements form a grayscale marking.

In a forty-seventh embodiment, the present application relates to the method of embodiment 46, wherein the grayscale marking forms a security mark.

In a forty-eighth embodiment, the present application relates to the method of embodiment 46, wherein the security mark is one of a shape, figure, symbol, design, letter, number, bar code, QR code, alphanumeric character, and indicia.

In a forty-ninth embodiment, the present application relates to the method of embodiment 46, wherein the cube corner elements comprise a thermoplastic polymer.

In a fiftieth embodiment, the present application relates to the method of embodiment 49, wherein the thermoplastic polymer is one of poly(carbonate), poly(methylmethacrylate), poly(ethyleneterephthalate), polyurethane, ethylene copolymers and ionomers thereof, and mixtures thereof.

In a fifty-first embodiment, the present application relates to the method of embodiment 46, wherein the thermally sheared cube corner elements have a reduced optically active volume of at least 50 percent.

In a fifty-second embodiment, the present application relates to the method of embodiment 46, wherein the thermally sheared cube corner elements have a displaced volume height between about 1 and about 30 percent.

In a fifty-third embodiment, the present application relates to the method of embodiment 46, wherein the grayscale marking is formed using one of a thermal printer on direct writing mode.

### EXAMPLES

The recitation of all numerical ranges by endpoint is meant to include all numbers subsumed within the range (i.e., the range 1 to 10 includes, for example, 1, 1.5, 3.33, and 10).

Those having skill in the art will appreciate that many changes may be made to the details of the above-described embodiments and implementations without departing from the underlying principles thereof. Further, various modifications and alterations of the present application will become apparent to those skilled in the art without departing from the spirit and scope of the invention. The scope of the present application should, therefore, be determined only by the following claims.

### Example 1

A retroreflective sheeting comprising a flat surface and a structured surface opposite the flat surface, the structured surface comprising a plurality of cube corner elements, was prepared as generally described in U.S. Patent Publication No. 2010/0103521 (Smith, et al), the entirety of which is incorporated herein by reference. Tooling was prepared by cutting three grooves onto a machinable metal using a high precision diamond tool such as “K&Y Diamond,” manufactured and sold by Mooers of New York, U.S.A. The tooling comprised a 3.2 mil primary groove pitch and isosceles base triangles having base angles of 61 and 61 degrees. Molten polycarbonate resin (such as obtained under the trade designation “MAKROLON 2407” by Mobay Corporation, Pennsylvania, U.S.A.) at a temperature of 550 deg. F. (287.8 deg. C.) was cast onto the heated tooling. Coincident with filling the cube recesses, additional polycarbonate was deposited in a continuous land layer above the tooling with a thickness of approximately 102 micrometer (0.004 inch). A previously extruded 51 micrometer (0.002 inch) thick poly(methylmethacrylate) (PMMA) film was laminated onto the top surface of the continuous polycarbonate land layer when the surface temperature was approximately 190.6 deg. C. (375 deg. F.) and the layered article was cooled down prior to being removed from the tooling. Retroreflectivity (RA) was measured following the procedure outlined in ASTM E-1709-09, “Standard Test Method for Measurement of Retroreflective Signs Using a Portable Retroreflectometer at a 0.2 Degree Observation Angle”, using a portable retroreflectometer (model “DELTA RETROSIGN GR3”, from Delta, Denmark). RA at 0.2° observation angle and −4° entrance angle was about was about 839 cd/lux/m².

A portion of cube corner elements of the retroreflective sheeting were thermally sheared using a direct/thermal transfer printer (model “SATO M10e”, obtained from SATO America, Inc., Charlotte, N.C.) configured in direct writing mode. The retroreflective sheeting was loaded into the printer with the structured surface oriented toward the thermal print head, and heat was selectively applied to the cube corner elements following a predetermined black square pattern. FIG. 3 is a digital photograph taken with a digital camera (model G11, available from Canon USA, Lake Success, N.Y.) of the retroreflective sheeting prepared as described in Example 1. As it may be seen, apices of cube corner elements were melted, and a “bridge” of molten material was formed between two adjacent thermally sheared cube corner elements. Measured retroreflectivity of the deformed retroreflective sheeting ranged from about 123 to 576 cd/lux/m² when using a power setting ranging from a darkness level of 1 to a darkness level of 5, and with the print darkness adjust potentiometer set to the maximum level.

### Example 2

Retroreflective sheeting was prepared as described in Example 1, except that a metallic coating was additionally applied to the cube corner elements. A retroreflectivity of about 1050 cd/lux/m² was measured, using the procedure described in Example 1.

The metallized sheeting was then loaded into the printer with the structured side facing the printing head. FIG. 7 is a digital picture of the retroreflective sheeting of Example 4. Heat was selectively applied to cube corner elements, resulting in a softening and flowing (“wrinkling”) of the metallic coating. The dark areas shown in FIG. 5 correspond to the areas where the reflective metallic coating deformed, tore, and became displaced from the apex of the elements, thermally shearing the underlying cube corner elements. Measured retroreflectivity of the thermally sheared retroreflective sheeting ranged from about 10 to 949 cd/lux/m² when using a power setting ranging from a darkness level of 1, with the print darkness adjust potentiometer set to the minimum level, to a darkness level of 5, with the print darkness adjust potentiometer set to the maximum level.

### Example 3

Retroreflective sheeting comprising thermally sheared cube corner elements was prepared as described in Example 1, except that an image of the Mona Lisa, by Leonardo da Vinci, was the selected pattern and loaded onto the printer. Portions of the structured surface of the retroreflective sheeting were exposed to varying degrees of heat, selectively deforming cube corner elements. More heat was applied to darker areas of the image, such as, for example, areas corresponding to Mona Lisa's hair and clothes. FIG. 6(a) is a digital photograph of the retroreflective sheeting of Example 3, taken under diffuse visible light conditions, using the digital camera. FIG. 6(b) is a digital photograph of the retroreflective sheeting of Example 3, taken under visible retroreflective conditions, using a flashlight and the digital camera. Under diffuse visible conditions, Mona Lisa's hair and clothes appear brighter. As explained above, cube corner elements which have been exposed to higher temperatures have larger displaced volume and displaced volume height. As a result, more light is scattered when incident upon the uneven surface of the thermally sheared cube corner elements. Under retroreflective conditions, scattered light does not return to the viewer, therefore larger displaced volumes and displaced volume heights appear dark to an observer.

### Example 4

Retroreflective sheeting comprising thermally sheared cube corner elements was prepared as described in Example 1, except that a pattern with four rows of spheres with varying shading was selected. FIG. 7(a) is a digital photograph of the retroreflective sheeting of Example 4 taken under diffuse visible conditions. FIG. 7(b) is a digital photograph of the retroreflective sheeting of Example 4 taken under retroreflective conditions. Similarly to Example 3, cube corner elements that were subjected to higher temperatures appear brighter under diffuse conditions (e.g., the outline of the spheres of the top two rows and the center of the spheres of the bottom two rows), whereas the cube corner elements subjected to lower temperatures were thermally sheared to a lesser extent and thus appear brighter under retroreflective conditions. The images show radial gradients of retroreflectivity across the image.

1-14. (canceled)

15. A retroreflective sheeting comprising:
a structured surface including cube corner elements, wherein at least some of the cube corner elements are thermally sheared cube corner elements; and
wherein the thermally sheared cube corner elements form a grayscale marking.

16. The retroreflective sheeting of claim 15, wherein the grayscale marking further includes:
a first pixel comprising a first plurality of thermally sheared cube corner elements having a first reduced optically active volume; and
a second pixel comprising a second plurality of thermally sheared cube corner elements having a second reduced optically active volume, different from the first reduced optically active volume.

17. The retroreflective sheeting of claim 1, wherein the grayscale marking is one of a graphic and photographic image.

18. The retroreflective sheeting of claim 15, wherein the grayscale marking forms a security mark.

19. The retroreflective sheeting of claim 18, wherein the grayscale marking is one of a shape, figure, symbol, design, letter, number, bar code, QR code, alphanumeric character, and indicia.

20. The retroreflective sheeting of claim 15, wherein the cube corner elements comprise a thermoplastic polymer.

21. (canceled)

22. The retroreflective sheeting of claim 15, wherein each of the thermally sheared cube corner elements have a reduced optically active volume of at least 50%.

23. (canceled)

24. The retroreflective sheeting of claim 15, further comprising a reflective layer adjacent the cube corner elements.

25. (canceled)

26. A retroreflective sheeting comprising:
a structured surface including an array of deformed cube corner elements having reduced optically active volumes, the array comprising multiple pixels, a first pixel comprising cube corner elements having a first total light return value and a second pixel, adjacent to the first pixel, comprising cube corner elements having a second total light return value, different from the first total light return value.

27. The retroreflective sheeting of claim 26, wherein the first and second pixels form a marking.

28. The retroreflective sheeting of claim 27, wherein the marking is a grayscale marking.

29. The retroreflective sheeting of claim, 26 wherein the marking forms a security mark.

30. The retroreflective sheeting of claim 29, wherein the security mark is one of a shape, figure, symbol, design, letter, number, bar code, QR code, alphanumeric character, and indicia.

31. The retroreflective sheeting of claim 26, wherein the cube corner elements comprise a thermoplastic polymer.

32-45. (canceled)

46. A method of making a retroreflective article comprising:
providing a retroreflective sheeting having a structured surface comprising a plurality of cube corner elements; and
thermally shearing at least some of the cube corner elements;
wherein the thermally sheared cube corner elements form a grayscale marking.

47. The method of claim 46, wherein the grayscale marking forms a security mark.

48. The method of claim 46, wherein the grayscale marking is one of a shape, figure, symbol, design, letter, number, bar code, QR code, alphanumeric character, and indicia.

49. The method of claim 46, wherein the cube corner elements comprise a thermoplastic polymer.

50. The method of claim 49, wherein the thermoplastic polymer is one of poly(carbonate), poly(methylmethacrylate), poly(ethyleneterephthalate), polyurethane, ethylene copolymers and ionomers thereof, and mixtures thereof

51. The method of claim 46, wherein each thermally sheared cube corner element has a reduced optically active volume of at least 50 percent.

52. The method of claim 46, wherein each thermally sheared cube corner element has a displaced volume height between about 1 and about 30 percent.

53. The method of claim 46, wherein the grayscale marking is formed using a thermal printer in direct writing mode.
